(19) United States
(12) Patent Application Publication
(10) Pub. No.: US 2013/0099417 A1
(43) Pub. Date: Apr. 25, 2013

(54) EMBOSSING UNIT AND EMBOSSING METHOD

(71) Applicants: Mauro Ricci, S. Piero a Vico (LU) (IT); Leonardo Boschi, San Leonardo in Treponzio (IT)

(72) Inventors: Mauro Ricci, S. Piero a Vico (LU) (IT); Leonardo Boschi, San Leonardo in Treponzio (IT)

(21) Appl. No.: 13/261,525

(22) PCT Filed: May 20, 2011
(86) PCT No.: PCT/IT11/00167

§ 371 Date: Dec. 31, 2012

(30) Foreign Application Priority Data
May 25, 2010 (IT) FI2010A000116

(51) Int. Cl. B31F 1/07

(52) U.S. Cl. CPC B31F 1/07
USPC 264/293; 425/385

(57) ABSTRACT

An embossing unit including at least one embossing roller, provided with embossing protrusions or recesses on a cylindrical surface; at least one pressure roller coated with an elastically yielding material and cooperating with the embossing roller; at least one actuator that presses the pressure roller and the embossing roller against each other; an automatic position adjustment system, to adjust the reciprocal position of the pressure roller and the embossing roller.

### TECHNICAL FIELD

The present invention relates to machines for converting continuous web materials. In particular, the invention relates to enhancements to so-called embossing units for processing paper or other materials, particularly cellulose materials. The invention also relates to embossing methods.

### BACKGROUND OF THE INVENTION

In the field of processing sheets or webs of paper or similar materials, the term embossing refers to a process of permanent deformation of the web material, which causes the production of raised zones or protuberances with a technical-functional or an aesthetic function, or a dual technical-functional and aesthetic function.

For example, in the processing of so-called “tissue” paper for the production of kitchen towels, toilet paper, paper handkerchiefs and napkins, or other similar items, embossing is used both to decorate the cellulose web material, and to impart particular technical characteristics to the material, for example an apparent thickness greater than the basic thickness of the starting ply, greater softness and absorption capacity, or other characteristics. Embossing is also used to produce protuberances on which to apply a glue which is used to bond together two or more plies to form a multi-ply web material.

Embossing units usually have at least one embossing roller, for example made of steel or another sufficiently hard material, on the cylindrical surfaces of which there are projections or recesses depending to the embossing design that one wishes to give to the material being processed. The embossing roller cooperates with a pressure roller coated with an elastically yielding material, typically natural or synthetic rubber. The pressure roller is pressed against the embossing roller so that the protuberances of the embossing roller penetrate at least partially into the elastically yielding thickness coating the pressure roller, or so that the elastically yielding material penetrates into the recesses on the surface of the embossing roller. The web material to be processed is fed through the embossing nip between the embossing roller and the pressure roller and it is here subjected to a permanent deformation caused by the pressure with which the two rollers are caused by the pressure with which the two rollers are pressed against each other. This process produces permanent deformations on the web material, with the possible partial breakage of some of the cellulose fibers that form the paper ply.

Some embossing units have several embossing rollers and several pressure rollers to process several plies simultaneously, which are then joined, for example by gluing, by applying a glue to at least some of the protuberances produced by embossing. In other embodiments, bonding is achieved by means of mechanical bonding. Typically, two or more plies are embossed separately between a respective embossing roller and a respective pressure roller; the separately-embossed plies are then laminated, that is they are fed through a laminating nip formed between two rollers pressed against each other to exert a bonding pressure. These rollers may be the same embossing rollers or an embossing roller and a laminating roller, or another roller. In some cases, an embossed ply and a non-embossed ply may be bonded in a similar manner.

When the embossing unit includes means for bonding two or more plies together by means of lamination, it is also referred to as an embossing-laminating unit. In the present description and in the attached claims, the term embossing unit refers in general to any machine, apparatus, device, assembly or unit that comprises at least one embossing roller and at least one pressure roller, and that may also comprise other embossing rollers, laminating rollers, pressure rollers, etc., as well as other accessories, devices, apparatus or other, intended to perform further operations on the ply or plies fed to the machine, such as for example, gluing, micro-embossing, printing, laminating, mechanical joining (ply-bonding) and others. An example of this type of embossing-laminating unit is described in US-A-2010/0000687 (WO-A-2008/105016).

The pressure roller is usually pressed against the embossing roller by means of a piston-cylinder actuator. Since processing of the web material depends substantially on the pressure exerted between the two rollers and therefore on the degree of elastic deformation undergone by the layer of elastically yielding coating on the pressure roller, it is necessary to provide means of regulating the reciprocal pressure between the pressure roller and the embossing roller. Traditionally, this is achieved with an adjustable abutment against which an arm pivoted to the structure of the unit is pressed, to which the piston-cylinder actuator is connected, and carrying the pressure roller. By adjusting the position of the abutment, it is possible to adjust the reciprocal position of the pressure roller and embossing roller and thus the pressure of one roller against the other, and thereby adjust the degree of deformation of the embossed web material and consequently the end result of the embossing operation.

When working conditions change, it is necessary to adjust the reciprocal position of the embossing roller and the pressure roller. This may happen, for example, when the characteristics of the web material to be processed change, when the embossing roller is replaced and the embossing design is changed, when one wishes to alter the characteristics of the end product, or for other reasons. In traditional machines, this adjustment or regulation of the reciprocal position of the rollers, and therefore of the reciprocal pressure exerted by them, requires the shutdown of the machine, access by the operator to the adjustable abutment, and manual adjustment of the abutment to move it to a different position corresponding to a new position of the pressure roller with respect to the embossing roller, and thus to a specific value for the pressure exerted by the pressure roller against the embossing roller. These operations are time-consuming and can lead to considerable loss of production caused by the machine being down. On the other hand, adjustment without prior stoppage of the machine is not permitted by safety regulations.

DE-A-102006036050 describes a printing unit comprising at least two rollers pressed against each other, between which a web substrate to be printed is fed. One of the two rollers is associated with a piezoelectric actuator. The piezoelectric actuator is positioned and made in such a way as to maintain a constant contact pressure between the two rollers.

### SUMMARY OF THE INVENTION

According to one aspect, the object of the invention is to entirely or partly solve one or more of the aforementioned problems. The object of a particularly advantageous embodiment of the invention is to simplify and speed up the embossing pressure adjustment operation, without the necessity of stopping the embossing unit and halting the processing of the web material.

In substance, according to a possible embodiment of the invention there is provided an embossing unit comprising at least one embossing roller, provided with embossing protrusions or recesses on a cylindrical surface; at least one pressure roller coated with an elastically yielding material and cooperating with the embossing roller; at least one actuator that presses the pressure roller and the embossing roller against each other. Provision is also made for an automatic position adjustment system, to adjust the reciprocal position of the pressure roller and the embossing roller. This enables adjustment, calibration and setting of the reciprocal position of the embossing roller and pressure roller to be carried out without needing to interfere with the machine's mechanical components. This enables these operations to be carried out more simply, faster and in greater safety.

According to some embodiments of the invention, the automatic adjustment system comprises at least one position detector for detecting the reciprocal position of the pressure roller and the embossing roller. The detector may be part of a control system with a control loop, by which the actuator is controlled as a function of the position detected by the position detector.

Although in principle the pressure roller can be held in a fixed position on a supporting structure and the embossing roller can be movable with respect to that structure, the detector is preferably associated with the pressure roller, which is mounted with an axis that moves with respect to a fixed structure; the embossing roller is mounted with an axis that is fixed with respect to said structure. More precisely, the embossing roller is generally mounted in such a way that it is possible to adjust the position of the axis thereof and block it once the desired position has been reached, which then remains fixed during operation of the embossing unit. The actuator presses the pressure roller against the embossing roller and the position detector detects directly or indirectly the position of the pressure roller with respect to the embossing roller. Keeping the position of the pressure roller fixed and moving the embossing roller by means of an actuator is not recommended, especially when the embossing unit comprises several embossing rollers that need to maintain a precisely-defined reciprocal position, for example to perform tip-to-tip or nested bonding of embossed plies. In this case, it is important to keep the position of the axes of the embossing rollers fixed, changing the position of the pressure rollers if necessary. In the case of simple embossing units, i.e. units having only one embossing roller and only one pressure roller, or several pairs of embossing and pressure rollers not fixed in a defined reciprocal position, it is possible in principle to change the position of the embossing roller while keeping the axis of the pressure roller fixed with respect to a fixed bearing structure. However, also in this case it is preferable to keep the axis of the embossing roller fixed because this roller is normally motorized, while the pressure roller is made to roll by being dragged by the embossing roller. It is therefore easier to move the axis of the driven roller rather than that of the motorized roller.

In some particularly advantageous embodiments of the invention, the automatic adjustment system comprises at least one control loop, wherein a controller generates a control signal for the actuator as a function of a position signal detected by the position detector and a desired value for the reciprocal position of the pressure roller and the embossing roller. The control loop makes it possible to maintain the position of the pressure roller by acting on the actuator, which presses the pressure roller against the embossing roller. The reciprocal position of the pressure roller and the embossing roller, and consequently the pressure between the two rollers, can be maintained without the need for a mechanical abutment. This makes it possible to simplify the machine construction, by eliminating abutments and their respective mechanical adjustment systems.

A control loop for the position of the pressure roller with respect to the embossing roller makes it possible to maintain the working condition of the embossing unit constant or substantially constant, by compensating for any variations in operating conditions due to disturbance factors. The term ‘substantially constant’ means a position that may oscillate within a certain range of values around an ideal position. This range may be greater or smaller depending on the need for precision and may also vary as the machine operating conditions change, for example when the material being processed changes. Some materials may withstand larger deviations in the reciprocal position of the rollers.

The term ‘substantially constant’ must therefore refer to a position that varies within a sufficiently small range to ensure an end result that is sufficiently constant for the intended purpose of a specific embossed product.

There may be various disturbance factors that can change the reciprocal position between the rollers, i.e. the extent of penetration of the protuberances of the embossing roller into the elastically yielding layer, or the penetration of the elastically yielding material into the embossing recesses on the embossing roller. For example, during operation, the temperature of the rollers may vary, leading to a consequent variation in the elastic module or in other physical properties of the elastically yielding coating of the pressure roller. The automatic adjustment system makes it possible to compensate for these variations by preventing a softening of the elastically yielding material from resulting in a greater interpenetration of the rollers (and therefore a smaller distance between the rotation axes) or at least the system makes it possible to reduce this variation. A variation in the distance between the roller axes due to a factor of this type could, if not corrected, lead to a corresponding variation in the characteristics of the end product. In fact, varying the distance between the rollers varies the embossing depth and therefore the dimensions of the embossing projections generated in the plies of web material. With the control device according to the invention, this phenomenon is avoided or reduced, increasing the end quality of the product, eliminating fluctuations in the characteristics of the embossing due, for example, to thermal variations and consequent variations to the elastic module of the coating material. A system for controlling the nip pressure, i.e. the pressure between the two rollers, would not allow this effect to be achieved, i.e. it would not be possible to compensate, for example, for the greater penetration of the embossing roller protuberances into the elastically yielding coating of the pressure roller resulting from the decreased stiffness of the yielding coating due to the increase in temperature.

With a device according to the invention it is also possible to compensate for any variations in the thickness of the web material.

When the pressure roller is controlled by means of two independent actuators at the two ends, with two separate control loops, it is also possible to compensate for variations in the thickness of the web material in the transversal direction of the web material.

A position detector also makes it possible to detect an anomalous variation in the position of the pressure roller with respect to the embossing roller. This anomalous variation could be due, for example, to the breakage of the web material being processed. If the web material breaks, it may accumulate in the embossing nip or it may wrap around the embossing roller or the pressure roller. In traditional machines, this condition is not detected and the mechanical parts are subjected to excessive stress as a result of the accumulation.

In an embossing unit according to the invention, a condition of this type can be detected by the control and adjustment system, which can generate an alarm signal and/or a signal to stop the embossing unit. Using a pneumatic piston-cylinder actuator offers the further advantage that in an anomalous situation of this type, for example due to the accumulation of web material wrapping around the embossing roller, the pneumatic piston-cylinder actuator behaves like a spring, imparting elastic yield to the system. In this way, even before the anomalous movement is detected by the position sensor, the embossing device is protected from excessive stress by this elastic yield of the piston-cylinder actuator resulting from the compression of the gas (usually air) in the cylinder chamber.

Preferably, for each roller whose position needs to be changed, for example for each pressure roller, provision is made for two actuators, each of which is fitted preferably with a detector and advantageously with a control loop, to control one actuator independently with respect to the other. As will be clarified below, this also makes it possible to maintain the parallelism between the embossing roller and the pressure roller during operation.

In some advantageous embodiments provision is made for a control unit and a user interface for setting operating parameters through said user interface, said operating parameters comprising at least one parameter which is a function of the reciprocal position between said pressure roller and said embossing roller. This also allows the operator to make immediate changes to the process parameters, without having to shut down the embossing unit. For example, it is possible to move the embossing roller and the pressure roller reciprocally closer or farther apart during operation as a function of the result obtained on the product exiting the embossing unit. Operations of this nature are not possible with traditional machines. In these latter machines, the machine needs to be shut down and the position of the mechanical abutment that determines the reciprocal position of the rollers adjusted. In some cases it is necessary to intervene more than once to achieve the desired result, resulting in long machine down times and loss of production. All this is avoided with the system described in the present invention.

Furthermore, it is possible to store series of process parameters relating to different products. These series of parameters can be retrieved by the operator from a memory and entered into the machine to rapidly switch from one type of product to another, without the need for shutdowns or long dataentry operations.

According to another aspect, the invention also relates to a method for embossing a web material in an embossing unit of the type comprising: at least one embossing roller, provided with embossing protrusions or recesses on a cylindrical surface; a pressure roller coated in elastically yielding material and cooperating with said embossing roller; and an actuator that presses said pressure roller and said embossing roller against each other. According to the invention, provision is made to automatically adjust the reciprocal position of said pressure roller and said embossing roller.

In some advantageous embodiments, provision is made to feed the web material between said embossing roller and said pressure roller pressed against each other; to detect the reciprocal position of said pressure roller and said embossing roller; to generate a control signal to maintain said reciprocal position around a preset value.

In some embodiments provision is made to detect the reciprocal position of said pressure roller and of said embossing roller in the vicinity of two opposed axial ends of said rollers and to generate two control signals to maintain, by means of two separate actuators, the reciprocal position of said pressure roller and said embossing roller around said preset value.

Further advantageous features and embodiments of the embossing unit and the embossing method according to the invention are set forth in the appended claims, which form an integral part of the present invention.

More generally, the present invention relates to a method for controlling the reciprocal position of two rollers pressed against each other, wherein the reciprocal position of one of said rollers with respect to the other is detected and a control loop provides an actuator, which pushes said two rollers against each other, with a control parameter to correct any variations in the reciprocal position detected with respect to a desired position of said two rollers.

### BRIEF DESCRIPTION OF DRAWINGS

The invention will be better understood by following the description and accompanying drawing, which shows a non-limiting practical embodiment of the invention. More in particular, in the drawing;

FIG. 1 shows a schematic side view of an embossing unit according to the invention; and

FIG. 2 shows a functional diagram of the position adjustment system for one of the pressure rollers.

### DETAILED DESCRIPTION OF EMBODIMENTS OF THE INVENTION

There will be described below an application of the present invention to a complex embossing-laminating unit, with two embossing rollers and two pressure rollers, as well as one laminating roller. However, it must be understood that the invention may also be advantageously embodied in simpler or other types of embossing units. For example, advantages may also derive from the application of the invention to simple embossing machines having only one embossing roller and one pressure roller.

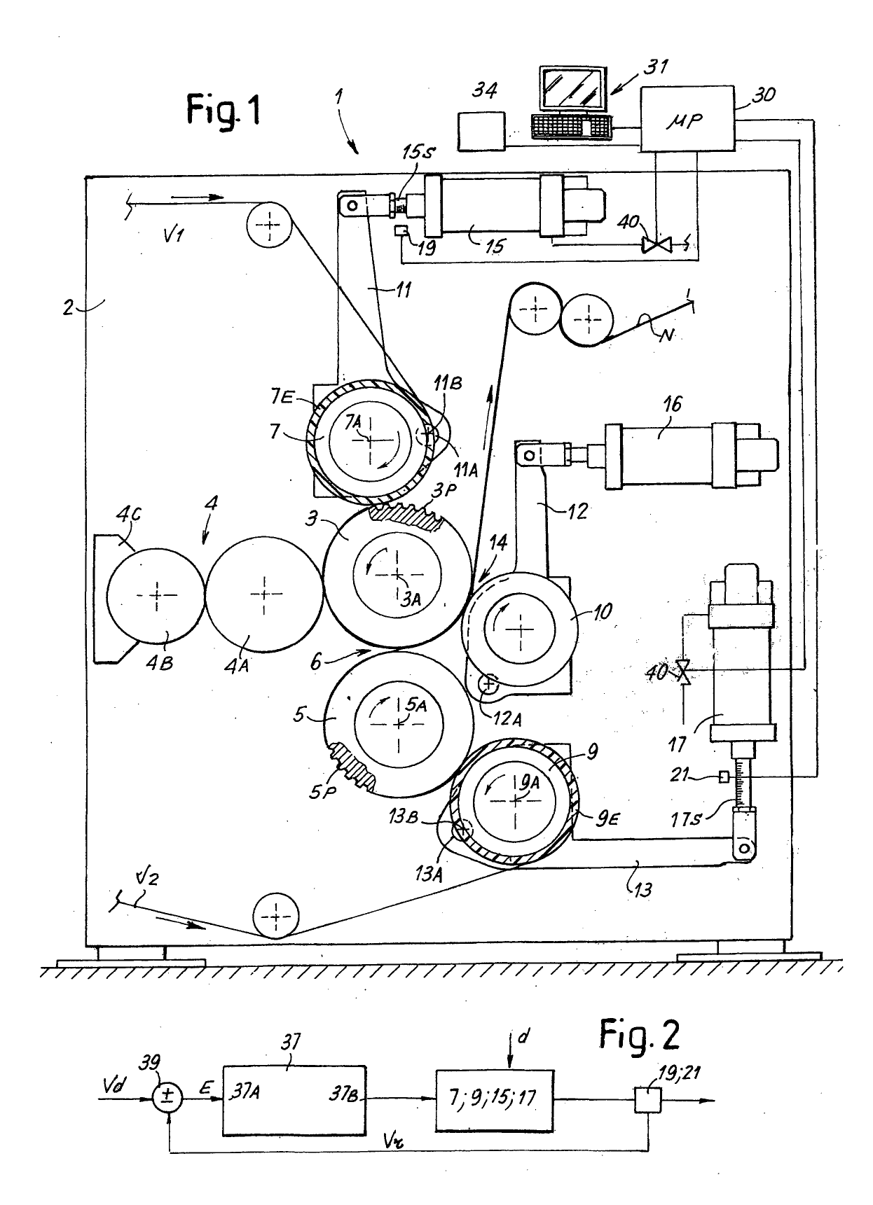

With reference to FIG. 1, in one possible embodiment the embossing unit, indicated as a whole with 1, comprises a first embossing roller 3 and a second embossing roller 5, cooperating respectively with a first pressure roller 7 and a second pressure roller 9. Each embossing roller 3, 5 has, on its cylindrical surface, a plurality of protuberances 3P, 5P, while each pressure roller 7, 9 comprises a cylindrical surface coated with a layer of elastically yielding material 7E and 9E. In the exemplary embodiment illustrated, the embossing rollers 3 and 5 are mounted with substantially fixed rotation axes 3A and 5A on a fixed support structure 2. Vice-versa, the pressure rollers 7 and 9 are mounted with adjustable rotation axes 7A and 9A so that the distance between each embossing roller 3, 5 and the corresponding pressure roller 7, 9 can be changed. Adjusting the distance between the rollers of each pair 3, 7 and 5, 9 changes the amount of elastic deformation undergone by the layer of elastically yielding coating 7E, 9E on each pressure roller 7, 9 due to the pressure against the protuberances 3P, 5P of the respective embossing roller.

Preferably, adjustment of the distance between the rollers of each pair is independent for the two pairs, although in some situations it may be possible to provide for a single adjustment for both pairs of rollers 3, 7 and 5, 9, for example when the two plies V1 and V2 of web material that must be embossed separately in the embossing nips between rollers 3, 7 and 5, 9 are the same and need to be subjected to an identical process.

In less advantageous embodiments provision may be made for the possible adjustment of the distance between only one of the two pairs of rollers 3, 7 and 5, 9. The methods of adjustment and control of the reciprocal position between the embossing roller 3, 5 and the corresponding pressure roller 7, 9 will be described in detail below.

In the example illustrated, the embossing roller 3 is associated with a glue applicator, indicated as a whole with 4, comprising an applicator roller 4A which receives the glue from an anilox roller 4B, which in turn draws the glue from a glue container 4C. The glue is applied to at least some of the protuberances formed by embossing on a ply V1 of web material fed through the embossing nip between the embossing roller 3 and the pressure roller 7.

Between the two embossing rollers 3 and 5 there is a lamination nip 6 where, in certain embodiments and/or in certain operating modes, the embossed and glued ply V1 is laminated together with a second ply V2 fed through the embossing nip between the embossing roller 5 and the pressure roller 9. The distance between the embossing rollers 3 and 5, and the reciprocal angular position of these rollers can be adjusted so as to obtain in the lamination nip 6 a reciprocal correspondence between at least some of the protuberances 3P of embossing roller 3 and at least some of the protuberances 5P of embossing roller 5 and a pressure between the mutually corresponding protuberances. In this case, thanks to the effect of compression and lamination between mutually corresponding protuberances of rollers 3 and 5, the two plies V1 and V2 are bonded together according to the so-called tip-to-tip technique.

In certain embodiments, downstream of the lamination nip 6 there is a laminating roller 10 which, in the example illustrated, is associated with the embossing roller 3. The laminating roller 10 is supported by arms 12 articulated around an axis 12A to the fixed structure 2. Along with the embossing roller 5, this forms a second lamination nip 14, where lamination can be executed between plies V1 and V2, according to a technique known to those skilled in the art as “nested” bonding, when the embossing rollers 3 and 5 are adjusted so as to have no reciprocal pressure between the protuberances 3P and 5P in the lamination nip 6. The reference number 16 indicates a piston-cylinder actuator that pushes the laminating roller 10 against the embossing roller 3. In practice, as for the pressure rollers 7 and 9, the roller 10 is pushed against the embossing roller 3 by two piston-cylinder actuators 16 placed at the two ends of the laminating roller 10 and cooperating with two arms 12.

In the example illustrated, each pressure roller 7, 9 is supported by a pair of arms, only one of which is visible in FIG. 1, and indicated with 11 and 13 respectively for the two pressure rollers 7 and 9. The arms 11, 13 are hinged at 11A and 13A to the fixed structure 2, such that they can pivot or turn about respective rotation or pivoting axes 11B, 13B, substantially parallel to the axes 3A, 5A and 7A, 9A of the rollers 3, 5, 7 and 9. The angular position of each arm 11, 13 is detected by a position detector that may be associated, for example, with the pin on which the respective arm is supported, to detect an angular position. In other embodiments, the detector may be positioned and made to read the position of another point of the respective arm 11, 13. In principle, a single detector may be provided for each roller 7, 9 but, for reasons that will be clarified below, it is preferable to provide one detector for each of the two arms 11, 11 and 13, 13 supporting each pressure roller 7, 9.

In the example illustrated, each arm 11, 13 is associated with at least one piston-cylinder actuator 15, 17. Preferably, a piston actuator 15, 17 is provided for each end of each pressure roller 7, 9, to obtain the most uniform pressure possible between the pressure roller and the embossing roller along the entire axial length of the rollers. Instead of a piston-cylinder actuafor (preferably pneumatic) as illustrated in the drawing, electric actuators may be used, for example linear electric motors, or a gear motor with a rack and pinion mechanism, a mechanical or hydraulic jack or any other actuator that can be adjusted by means of a control loop as described below. In general, the actuator or actuators associated with a pressure roller will be strong enough to apply sufficient force to move the arms 11, 13 and thus the rollers into the desired position. The position of the arms 11, 13 is set so as to obtain, at the embossing nip formed by each embossing roller 3, 5 and the corresponding pressure roller 7, 9, a certain deformation of the layer of elastically yielding coating 7E, 9E on the respective pressure roller 7, 9 and therefore a certain interpenetration between the protuberances 3P, 5P and the elastic coating 7E, 9E.

A position detector, schematically indicated with 19 for the arm 11 (or for each arm 11 of the roller 7) and with 21 for the arm 13 (or each arm 13 of the roller 9), comprises, in this exemplary embodiment, an encoder that detects the position of the stem 15S, 17S of the respective piston-cylinder actuator 15, 17. There may be provided a single loop for controlling the position of the pressure roller 7 or 9, which may use, for example, the signal from only one of the position detectors, or a combination of the two signals. However, preferably there are provided separate, independent control loops for each detector and therefore for each actuator 15, 17 of each pressure roller 7, 9.

In some types of embossing it is important to set a certain degree of deformation of the web material that passes through the embossing nips and therefore a certain reciprocal position of the embossing roller and the pressure roller. In the example illustrated, this is achieved by means of the combined effect of the position detectors 19 or 21 and the actuators 15 or 17. In practice, a certain reciprocal position of the embossing roller 3 or 5 and the pressure roller 7 or 9 corresponds to a certain depth of embossing of the web material and thus to a certain position of the pressure roller 7 or 9 detectable directly or indirectly by means of the respective detector 19 or 21. If for each pressure roller there are provided two detectors associated with the two support arms placed at the ends of the pressure rollers, it is possible to control and correct any variation between the positions detected at the two ends of the roller.

The embossing unit 1 or the processing line in which it is inserted, advantageously comprises a programmable central control unit, by means of which it is possible to set a certain reciprocal position for the embossing rollers and pressure rollers of one and/or of the other of the two pairs 3, 7 and 5, 9. The central control unit, schematically indicated with 30 in FIG. 1, is connected to the position detector 19 and/or 21 of the respective pressure roller 7, 9 and to the corresponding actuator 15 and/or 17. Thus, using the interface generally indicated with 32, the operator can set a certain reciprocal position of the pressure rollers and the embossing rollers. In some embodiments provision may be made to store in a memory support, schematically indicated with 34, a set or series of operating parameters for the embossing unit 1, comprising at least one datum corresponding to a certain position of at least one of the pressure rollers 7, 9 with respect to the respective embossing roller 3, 5. Preferably, each set of parameters comprises data corresponding to the reciprocal position of each pressure roller 7, 9 with respect to the corresponding embossing roller 3, 5.

The embossing unit 1 may also advantageously comprise a control loop for each pair of embossing roller and pressure roller, or preferably for each actuator associated with each pair of rollers. FIG. 2 schematically shows a functional block diagram of a possible control loop for one of the actuators of one of the two pressure rollers 7, 9. The various control loops may be substantially identical.

The control loop, indicated as a whole with 35, comprises a controller 37 with an input 37A and an output 37B. This receives an input error signal E generated by a comparator 39 which compares a preset value, or desired value, for the controlled distance (i.e. a position which is a function of the reciprocal position between the pressure roller and the embossing roller) with a real value Vr of said controlled distance. The output 37B of the controller 37 is a command signal for the actuator 15 or 17 with which the controller 37 is associated. The position of the actuator 15, 17 is detected by means of the detector (encoder) 19, 21 which provides the real value Vr of the controlled distance to the comparator 39.

When one wishes to produce a certain type of web material N formed by bonding two plies V1 and V2 embossed with a certain embossing depth (possibly different for the two plies), the operator sets the reciprocal distance of the rollers 3, 7 and 5, 9, possibly using data stored in the memory 34 containing sets or series of pre-saved values. The pressure rollers 7 and 9 are brought to the desired position by the actuators 15, 17 resulting in more or less deformation of the layer of elastically yielding coating 7E, 9E and the embossing unit 1 begins processing the plies.

During processing of the plies V1 and V2, the control system described above maintains the set reciprocal distance thanks to the control loops associated with the two actuators 15, 17. Therefore, any disturbances (schematically indicated with “d” in the diagram shown in FIG. 2) to the controlled system consisting of the rollers, arms and actuators, that tend to change the reciprocal position of the pressure rollers and the embossing rollers, are compensated for by means of the guidance signal generated by the controller 37.

When the actuator 15, 17 is a hydraulic piston-cylinder actuator, control can be achieved by means of a simple proportional valve: when a variation is detected with respect to the desired position Vd (error E), the valve is commanded to increase or reduce the pressure in the cylinder of the piston-cylinder actuator, depending on the direction of the variation in the real position Vr with respect to the desired position Vd. In the diagram shown in FIG. 1 the proportional valve constituting or making up part of the controller 37 is schematically indicated with 40 for both pressure rollers.

In other embodiments, the controller 37 may be made in a more complea manner to obtain more accurate, stable adjustment. In particular, a proportional-integral controller (PI) or a proportional-integral-derivative controller (PID) may be used advantageously in combination with an electronic actuator.

To take account of wear to the layer of elastically yielding coating 7E, 9E on the pressure rollers 7, 9 and possibly also of wear to the embossing rollers 3, 5, calibration of the control system may be carried out at suitable intervals (as a function of the quantity and/or quality of the web material processed). This calibration may be carried out, for example, by interposing a thickness gauge at the ends of the embossing nip formed by the respective pair of rollers 3, 7 or 5, 9. The rollers 3, 7 or 5, 9 are brought to a reciprocal distance (of the respective outer cylindrical surfaces) known and defined by the thickness gauge. This position is taken as the zero reference value for the control system. Calibration is carried out by interposing a thickness gauge at both ends of the embossing nip to guarantee that the two rollers 3, 7 or 5, 9 are positioned with parallel axes.

Providing for each pressure roller 7, 9 a pair of actuators 15 or 17 at the two ends, each associated with a respective support arm 11 or 13 for the pressure roller, and providing two control systems with respective control loops 35 of the type illustrated in FIG. 2, one for each actuator 15 or 17, a system is obtained that can efficiently maintain a sufficient degree of parallelism between the rollers 3, 7 or 5, 9 during processing of the web material.

An adjustment system equivalent to that described above for the pressure rollers 7 and 9 may also be provided for the laminating roller 10, although it is less important, since in the second laminating nip 14 the plies are normally only bonded and not embossed, and so there is usually no need to adjust and control a particular reciprocal position between the laminating roller 10 and the embossing roller 3. However, in the event that it is desired to carry out embossing or re-embossing of the web material N in the second laminating nip 14, it could be advantageous to also provide a system for adjusting and controlling the reciprocal position of the rollers 3 and 10.

It is understood that the drawing only shows an example provided by way of a practical arrangement of the invention, which may vary in forms and arrangements without however departing from the scope of the concept underlying the invention. Any reference numbers in the appended claims are provided to facilitate reading of the claims with reference to the description and to the drawing, and do not limit the scope of protection represented by the claims.

1-17. (canceled)

18. An embossing unit comprising
at least one embossing roller, provided with embossing protrusions or recesses on a cylindrical surface thereof;
at least one pressure roller, having an elastically yielding material on an outer surface thereof, and cooperating with a respective one or more embossing roller of said at least one embossing roller;
at least one actuator that presses a respective pressure roller of said at least one pressure roller and a respective embossing roller of said at least one embossing roller against each other;
an automatic position adjustment system to adjust a reciprocal position of said at least one pressure roller and said at least one embossing roller;
wherein said automatic adjustment system comprises at least one position detector to detect the reciprocal position of said at least one pressure roller and said at least one embossing roller; and wherein said at least one actuator is controlled as a function of the position detected by said at least one position detector.

19. The embossing unit according to claim 18, wherein said actuator is a pneumatic actuator.

20. The embossing unit according to claim 18, wherein said at least one detector is associated with the pressure roller, wherein said pressure roller is mounted with a movable axis with respect to a fixed structure, and the embossing roller is mounted with a fixed axis with respect to said fixed structure; said at least one actuator pushes the pressure roller against the embossing roller; and said at least one position detector directly or indirectly detects the position of the pressure roller with respect to the embossing roller.

21. The embossing unit according to claim 19, wherein said at least one detector is associated with the pressure roller, wherein said pressure roller is mounted with a movable axis with respect to a fixed structure, and the embossing roller is mounted with a fixed axis with respect to said fixed structure; said at least one actuator pushes the pressure roller against the embossing roller; and said at least one position detector directly or indirectly detects the position of the pressure roller with respect to the embossing roller.

22. The embossing unit according to claim 18, wherein said automatic adjustment system comprises at least one control loop, wherein a controller generates a control signal for said at least one actuator as a function of an error between the reciprocal position detected by said at least one position detector and a desired reciprocal position between said pressure roller and said embossing roller.

23. The embossing unit according to claim 19, wherein said automatic adjustment system comprises at least one control loop, wherein a controller generates a control signal for said at least one actuator as a function of an error between the reciprocal position detected by said at least one position detector and a desired reciprocal position between said pressure roller and said embossing roller.

24. The embossing unit according to claim 22, wherein said controller is selected from the group consisting of a proportional controller, a proportional-integral controller, a proportional-integral-derivative controller.

25. The embossing unit according to claim 18, wherein said at least one actuator is a piston-cylinder actuator.

26. The embossing unit according to claim 25, wherein said piston-cylinder actuator is combined with a proportional valve for adjusting pressure of fluid in the piston-cylinder actuator.

27. The embossing unit according to claim 25, wherein said at least one position detector is arranged to detect a position of a stem of the piston-cylinder actuator.

28. The embossing unit according to claim 18, further comprising two actuators and two position detectbrs for said at least one pressure roller.

29. The embossing unit according to claim 28, wherein a control loop is associated with each of said two position detectors and with each of said two actuators, said control loops controlling said two actuators independently from each other.

30. The embossing unit according to claim 18, further comprising a control unit and an user interface for setting operating parameters through said user interface, said operating parameters comprising at least one parameter which is a function of the reciprocal position between said pressure roller and said embossing roller.

31. The embossing unit according to claim 30, wherein a memory is associated with said control unit, in which data relative to a plurality of operating conditions of the embossing unit can be stored, selectable by an user through said user interface, each operating condition being characterized by at least one parameter which is a function of the reciprocal position between said pressure roller and said embossing roller.

32. The embossing unit according to claim 18, further comprising a plurality of pressure rollers cooperating with said at least one embossing roller, each of said pressure rollers being associated with a corresponding automatic position adjustment system, for adjusting the reciprocal position of said pressure roller and said embossing roller.

33. The embossing unit according to claim 18, further comprising a plurality of embossing rollers, each cooperating with at least one pressure roller, each of said at least one pressure roller being associated with a corresponding automatic position adjustment system, for adjusting the reciprocal position of said pressure roller and of a corresponding embossing roller.

34. A method for embossing a web material in an embossing unit, the embossing unit comprising at least one embossing roller, provided with embossing protrusions or recesses on a cylindrical surface thereof; at least one pressure roller having an elastically yielding material on an outer surface thereof and cooperating with said embossing roller; and at least one actuator that presses said pressure roller and said embossing roller against each other; said method comprising steps of providing an automatic position adjustment system with at least one position detector for detecting a reciprocal position of said at least one pressure roller and said at least one embossing roller; and controlling said at least one actuator as a function of the reciprocal position detected by said at least one position detector in order to automatically adjust the reciprocal position of said pressure roller and said embossing roller.

35. The method according to claim 34, further comprising feeding the web material between said embossing roller and said pressure roller pressed against each other; detecting the reciprocal position of said pressure roller and said embossing roller; and generating a control signal to maintain said reciprocal position around a preset value.

36. The method according to claim 35, further comprising steps of detecting the reciprocal position of said pressure roller and of said embossing roller in a vicinity of two opposite axial ends of each of said pressure roller and said embossing roller; and generating two control signals to maintain, by two separate actuators, the reciprocal position of said pressure roller and of said embossing roller around said preset value.
